(19) United States
(12) Patent Application Publication
(10) Pub. No.: US 2003/0131058 A1
(43) Pub. Date: Jul. 10, 2003

(54) Object-oriented enabling of e-mail notification in a federated content management system

(75) Inventor: Alan Tsu-I Yaung, San Jose, CA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: INTERNATIONAL BUSINESS MACHINES CORPORATION, ARMONK, NY

(21) Appl. No.: 10/041,404

(22) Filed: Jan. 8, 2002

(51) Int. Cl. G06F 15/16

(52) U.S. Cl. 709/206; 709/203

(57) ABSTRACT

There is provided a process, executed in an object-oriented programming environment, for sending an e-mail notification to a recipient. The process includes the steps of instantiating an object, and providing to the object a name of an e-mail server and an e-mail address for the recipient. The object sends the e-mail notification to the e-mail server for the e-mail address.

### BACKGROUND OF THE INVENTION

1. Field of the Invention

The present invention relates to electronic mail (e-mail), and more particularly, to an object-oriented framework for enabling e-mail notification in a federated content management system.

2. Description of the Prior Art

An enterprise, for example, a large business, may employ a variety of hardware platforms and storage systems for processing and storing information. The information, i.e., content, may include documents, images, audio data and video data. Enterprise computing refers to a concept of providing solutions that serve the enterprise, as opposed to targeting the solutions to serve the needs of an individual. The definitions of several terms relating to the concept of enterprise computing are set forth below.

“Federated content management” is a management of content in a system having a plurality of back-end servers.

A “federated search” is a search facility across multiple back-end servers.

“Federated workflow” is a facility for routing content from multiple back-end servers.

A “back-end datastore” is a back-end server for storing content.

For example, one such a federated content management system supports federated search and federated workflow across various back-end datastores. The system can perform tasks, such as (a) accessing unstructured digital content, for example, text, Extensible Markup Language (XML) and hypertext markup language (HTML) files, document images, computer output, audio and video, (b) accessing structured enterprise information via connectors to relational databases, (c) accessing business intelligence information stored in a metadata store, (d) integrating objects accessed within business process workflows, (e) categorizing search results against a predefined taxonomy, and (f) customizing summarization reports from search results. However, the system does not provide a mechanism that allows a user to easily send an e-mail notification to another user in a federated content management application.

In order to send an e-mail notification in a federated content management system, an application developer must implement logic to do so inside an application. The developer needs to understand details of a protocol that the developer selects to send the e-mail notification (e.g., Simple Mail Transfer Protocol (SMTP), Post Office Protocol version 3 (POP3), etc.). Consequently, development cost is increased. Moreover, logic implemented by the developer may not be reusable by other application developers. In addition, the implementation of e-mail notification outside the federated content management application will not provide a seamless integration with a federated content management object-oriented application program interface (API) set.

### SUMMARY OF THE INVENTION

It is an object of the present invention to provide an object-oriented program module for enabling e-mail notification in a federated content management system.

It is another object of the present invention to provide such a module that is convenient and easy for an application developer to use.

It is a further object of the present invention to provide such a module that is usable in a plurality of applications.

It is still a further object of the present invention to provide such a module that integrates with a federated content management object-oriented application program interface (API) set.

These and other objects of the present invention are achieved by a process, executed in an object-oriented programming environment, for sending an e-mail notification to a recipient. The process includes the steps of instantiating an object, and providing to the object a name of an e-mail server and an e-mail address for the recipient. The object sends the e-mail notification to the e-mail server for the e-mail address.

### BRIEF DESCRIPTION OF THE DRAWINGS

FIG. 1 is a graphical model of an object-oriented framework for enabling e-mail notification in accordance with the present invention.

FIG. 2 shows an exemplary design of a program module for a mail notification interface.

FIG. 3 shows an exemplary design of a program module for a mail notification SMTP class.

FIG. 4 is an exemplary application program that invokes an API for sending an e-mail notification to a recipient.

FIG. 5 is an example of a trace of an execution the application program of FIG. 4.

FIG. 6 shows an e-mail notification composed with the parameters specified in the exemplary application program of FIG. 4.

FIG. 7 is a block diagram of a computer system suitably configured for employment of the present invention.

### DESCRIPTION OF THE INVENTION

The present invention provides an object-oriented framework for enabling e-mail notification in a federated content management system. For the purpose of clarity, an exemplary embodiment of the present invention is described herein in the context of a federated content management system. However, the present invention is not limited to a federated content management environment, but instead, the concepts of the present invention are generally applicable to any appropriate database product.

An API is a program module provided by a computer operating system or by an application program, with which a programmer writing an application can make a request of the operating system or another application. The invention includes two principal components: (1) an object-oriented framework for enabling e-mail notification and (2) an object-oriented API design supporting the framework.

When an e-mail notification capability is embedded in a federated content management system, it addresses issues relating to cost, reusability and integration in a pragmatic fashion. Other than calling an API, no additional development cost is needed. Thus, application developers can focus on the application logic. Program code for the e-mail notification capability is highly reusable through the use of the API. Also, the e-mail notification capability is seamlessly integrated with the federated content management system.

In the context of object oriented programming, a class is a template for defining characteristics of a set of data structures and routines. Variables and routines defined by the class are respectively known as member variables and methods. When a program wishes to use those specific data structures and routines, the program instantiates the class, thus creating an object of the class. A “method” is an operation that an object can perform. For example, by analogy, a “bank account” can be an object with a number of methods such as “deposit”, “withdraw”, etc.

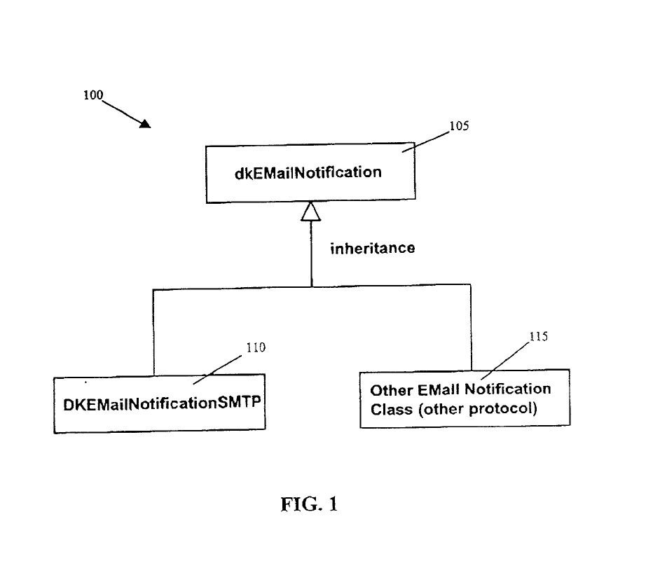

FIG. 1 is a graphical model 100 of an object-oriented framework for enabling e-mail notification in accordance with the present invention. Using Object Modeling Technique (OMT) notation, each rectangle in FIG. 1 represents a class. Model 100 includes a dkEMailNotification interface 105, a DKEMailNotificationSMTP class 110, and an “other” e-mail notification class 115. The link with a small triangle represents an inheritance relation.

dkEMailNotification interface 105 is an interface for e-mail notification regardless of the underlying protocol used for sending the e-mail notification. DKEMailNotificationSMTP class 110 is a class implementing dkEMailNotification interface 105 and providing the e-mail notification capability based on SMTP. The framework of model 100 is flexible and allows other protocols, i.e., other e-mail notification class 115, to be implemented on the same dkEMailNotification interface 105. Although the present invention is described as using SMTP, other protocols, for example, POP3, can be easily integrated into its object-oriented framework.

The following paragraphs describe an object-oriented API design of the present invention. Java™ is an object-oriented programming language developed by Sun Microsystems, Inc. The object-oriented API design of the present invention provides a set of functions for developers to incorporate the e-mail notification capability into applications written in Java™.

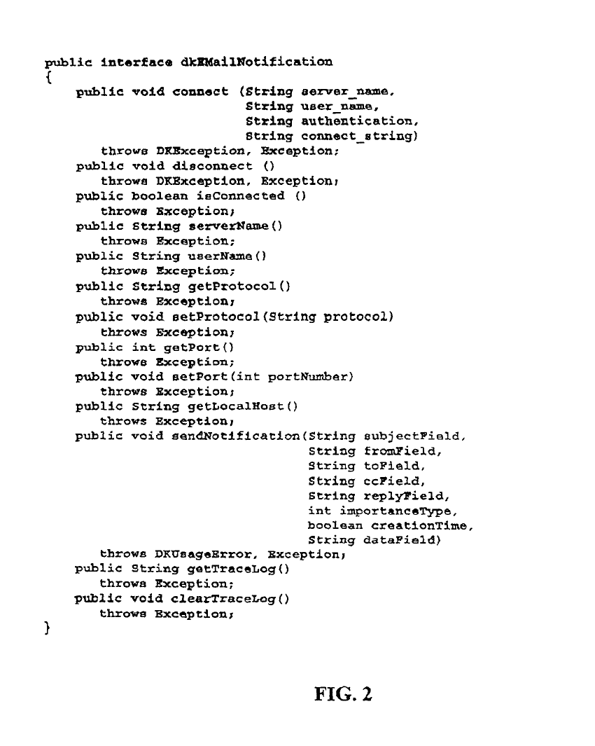

FIG. 2 shows an exemplary design of a program module for dkEMailNotification interface 105. dkEMailNotification interface 105 defines a set of basic methods for e-mail notification. It specifies the interface definition of these methods without implementation detail. dkEMailNotification interface 105 defines the design of a generic e-mail notification mechanism. Furthermore, the design is consistent with a federated content management system framework.

The methods of dkEMailNotification interface 105 are described below. The methods are presented in accordance with the Java™ convention.

Method name

Method description

Exception thrown

Parameters used in the method

Return value

(A) connect—Connects to the named server with user name, authentication, and connect string information.

public void connect (String server_name,

String user_name,

String authentication,

String connect_string) throws DKException, Exception;

Parameters:

server_name—name of the server.

user_name—user name.

Authentication—authentication of the user.

connect_string—optional connection string.

(B) disconnect—Disconnects from the server.

public void disconnect ( ) throws DKException, Exception;

(C) isConnected—Returns the status of connecting to the server.

public boolean isConnected ( ) throws Exception;

Return: Boolean value indicating the connection status.

(D) serverName—Returns the server name.

public String serverName( ) throws Exception;

Return: server name.

(E) userName—Returns the user name.

public String userName( ) throws Exception;

Return: user name.

(F) getProtocol—Returns the protocol name.

public String getProtocol( ) throws Exception;

Return: protocol name.

(G) setProtocol—Sets the protocol name.

public void setProtocol(String protocol) throws Exception;

Parameters:

protocol—the protocol name.

(H) getPort—Returns the port number.

public int getPort( ) throws Exception;

Return: the port number.

(I) setPort—Sets the port number.

public void setPort(int portNumber) throws Exception;

Parameters: port—the port number.

(J) getLocalHost—Returns the local host name.

public String getLocalHost( ) throws Exception;

Return: name of the local host.

(K) sendNotification—Sends the e-mail notification.

public void sendNotification(String subjectField,

String fromField,

String toField,

String ccField,

String replyField,

int importanceType,

boolean creationTime,

String dataField) throws DKUsageError, Exception;

Parameters:

subjectField—subject of the notification.

fromField—sender's e-mail address.

toField—recipient's e-mail address.

ccField—carboncopy e-mail address, optional.

replyField—reply e-mail address, optional.

importanceType—Urgent(2), FYI(1), or Normal(0 default), optional.

creationTime—flag (default is false) to indicate whether the creation timestamp is required, optional.

dataField—content of the notification.

(L) getTraceLog—Returns the tract log.

public String getTraceLog( ) throws Exception;

Return: the trace log.

(M) clearTraceLog—Clears the trace log.

public void clearTraceLog( ) throws Exception;

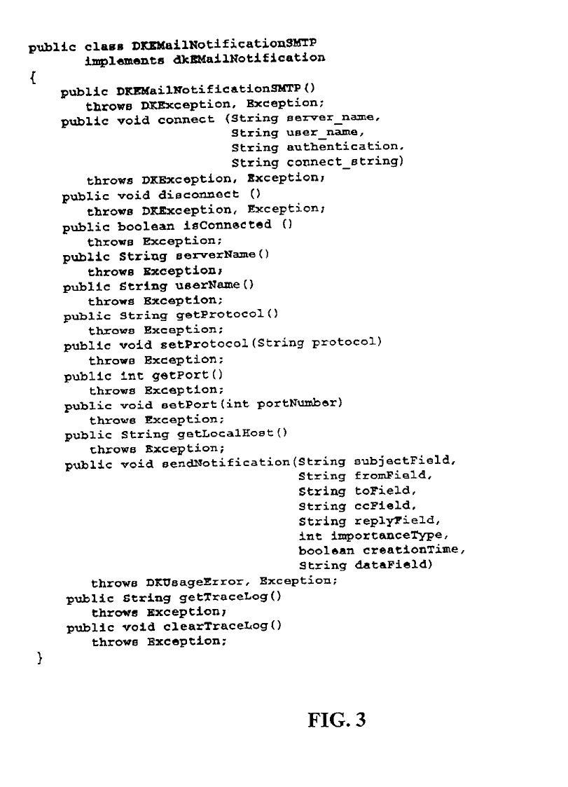

FIG. 3 shows an exemplary design of a program module for DKEMailNotificationSMTP class 110. DKEMailNotificationSMTP class 110 implements dkEMailNotification interface 105 supporting the SMTP protocol.

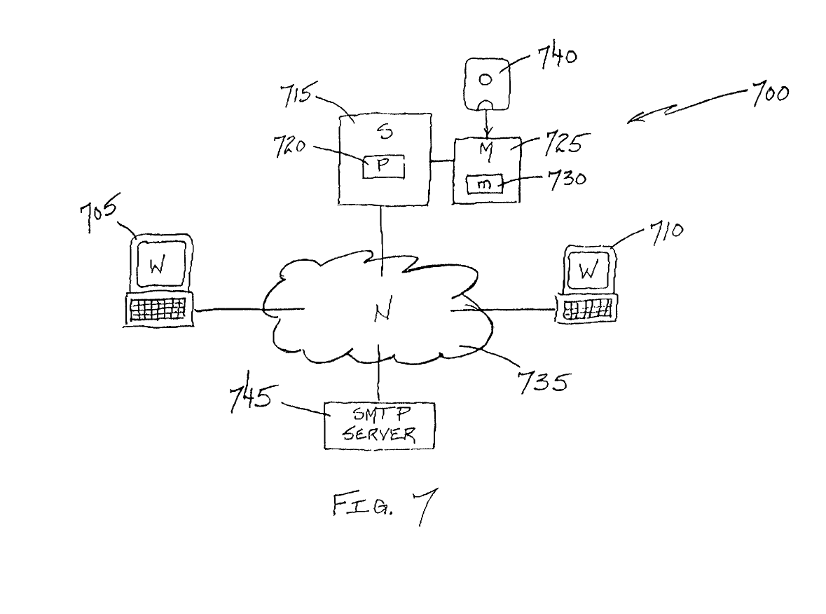

In a typical scenario, an application program running on a workstation invokes an API that connects to a program module on a server (see FIG. 7, reference number 730) and instantiates DKEMailNotificationSMTP class 110, which in turn connects to an SMTP server. The application program then composes an e-mail notification, sends the e-mail notification to DKEMailNotificationSMTP class 110, and disconnects from DKEMailNotificationSMTP class 110.

public void sendNotification(String subjectField,

String fromField,

String toField,

String ccField,

String replyField,

int importanceType,

boolean creationTime,

String dataField);

“fromField”, “toField”, and “ccField” define a party to be notified. An SMTP server sends the e-mail. The methods employed by the DKEMailNotificationSMTP class 110 are described below.

(a) DKEMailNotificationSMTP constructor—Constructs a DKEMailNotificationSMTP object.

public DKEMailNotificationSMTP( ) throws DKException, Exception;

(b) connect—Connects to the named server. Use “” for user name, authentication, and connect string information since they are not required in an SMTP server.

public void connect (String server_name,

String user_name,

String authentication,

String connect_string) throws DKException, Exception;

Parameters:

server_name—name of the server.

user_name—user name, not required in this method.

Authentication—authentication of the user, not required in this method.

connect_string—optional connection string.

(c) disconnect—Disconnects from the server.

public void disconnect ( ) throws DKException, Exception;

(d) isConnected—Returns the status of connecting to the server.

public boolean isConnected ( ) throws Exception;

Return: Boolean value indicating the connection status.

(e) serverName—Returns the server name.

public String serverName( ) throws Exception;

Return: server name.

(f) userName—Returns the user name.

public String userName( ) throws Exception;

Return: user name.

(g) getProtocol—Returns the protocol name.

public String getprotocol( ) throws Exception;

Return: protocol name.

(h) setProtocol—Sets the protocol name.

public void setProtocol(String protocol) throws Exception;

Parameters:

protocol—the protocol name.

(i) getPort—Returns the port number.

public int getPort( ) throws Exception;

Return: the port number.

(j) setPort—Sets the port number.

public void setPort(int portNumber) throws Exception;

Parameters:

port—the port number.

(k) getLocalHost—Returns the local host name.

public String getLocalHost( ) throws Exception;

Return: name of the local host.

(l) sendNotification—Sends the e-mail notification.

public void sendNotification(String subjectField,

String fromField,

String toField,

String ccField,

String replyField,

int importanceType,

boolean creationTime,

String dataField)

throws DKUsageError, Exception;

Parameters:

subjectField—subject of the notification.

fromField—sender's e-mail address.

toField—recipient's e-mail address.

ccField—carboncopy e-mail address, optional.

replyField—reply e-mail address, optional.

importanceType—Urgent(2), FYI(1), or Normal(0 default), optional. creationTime—flag (default is false)to indicate whether the creation timestamp is required, optional.

dataField—content of the notification.

(m) getTraceLog—Returns the tract log.

public String getTraceLog( ) throws Exception;

Return: the trace log.

(n) clearTraceLog—Clears the trace log.

public void clearTraceLog( ) throws Exception;

In its preferred embodiment, the e-mail notification of the present invention includes the following fields:

(1) subjectField—subject of the notification.

Example: “Testing E-Mail Notification from EIP”

(2) fromField—sender's e-mail address.

Example: “ayaung@us.ibm.com”

(3) toField—recipient's e-mail address.

Example: “ayaung@us.ibm.com”

(4) ccField—carboncopy e-mail address, optional.

Example: “ayaung@us.ibm.com”

(5) replyField—reply e-mail address, optional.

Example: “ayaung@us.ibm.com”

(6) importanceType—Urgent(2), FYI(1), or Normal(0 default), optional.

Example: 1 forFYI

(7) creationTime—flag (default is false) to indicate whether the creation timestamp is required, optional.

Example: True for required for creation timestamp

(8) dataField—content of the notification.

Example: “This is an e-mail notification. \n\n”

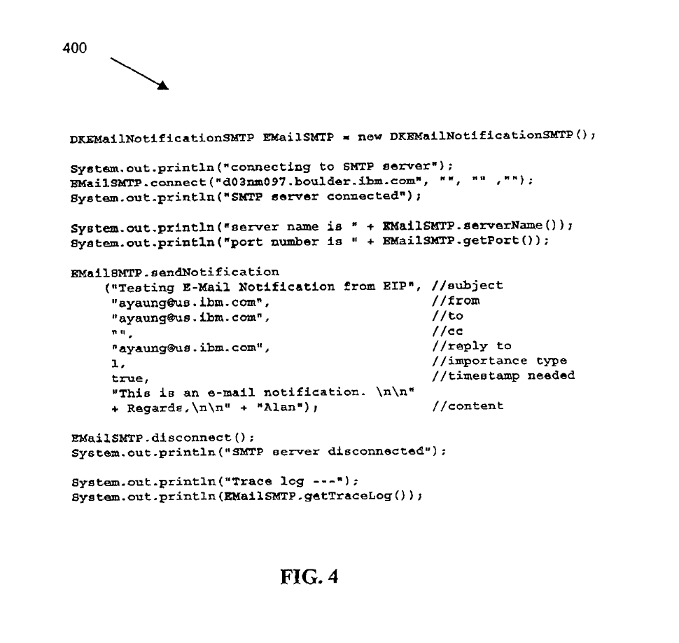

FIG. 4 is an exemplary application program 400 as could be written by an application program developer to invoke the API of the present invention for sending an e-mail notification to a recipient. Application program 400 is running on a workstation. When application program 400 is executed, an instance of DKEMailNotificationSMTP class 110 is instantiated on a server. Also during the execution of application program 400, the “connect” method is called to establish a connection between the workstation and a specified SMTP server, in this example, “d03nm097.boulder.ibm.com”. Application program 400 lists the name of the SMTP server and the port number.

After the workstation is successfully connected to the server, application program 400 composes an e-mail notification sends the e-mail notification to the server. In FIG. 4, the e-mail notification has a subject of “Testing E-Mail Notification from EIP”. It is sent from “ayaung@us.ibm.com” i.e., a first party, to ayaung@us.ibm.com, i.e., a second party or a recipient. A reply should be sent to “ayaung@us.ibm.com”. Its importance type is “FYI” and a timestamp of creation is required.

Thereafter, application program 400 disconnects from the SMTP server. Lastly, application program 400 displays a trace log of the responses from the SMTP server.

To summarize the relationships, functions and responsibilities of dkEMailNotification interface 105 and DKEMailNotificationSMTP class 110, refer again to FIG. 1. dkEMailNotification interface 105 (FIG. 2) defines a generic interface of methods for e-mail notification in accordance with the present invention. dkEMailNotification interface 105 only provides the definition of the methods without any actual implementation. DKEMailNotificationSMTP class 110 (FIG. 3) is derived from dkEMailNotification interface 105, and implements the code for these methods. In DKEMailNotificationSMTP class 110, the “connect” method makes an actual connection to an SMTP server. After the SMTP server is connected, a user can issue the sendNotification method as shown in FIG. 4.

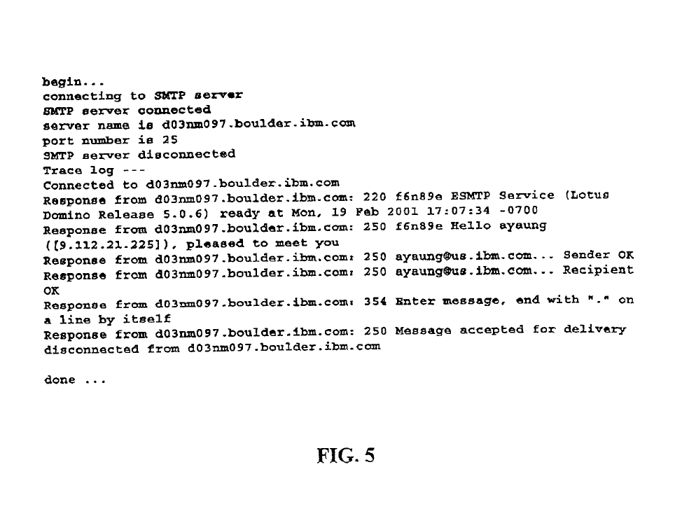

FIG. 5 is an example of a trace of an execution of application program 400 of FIG. 4.

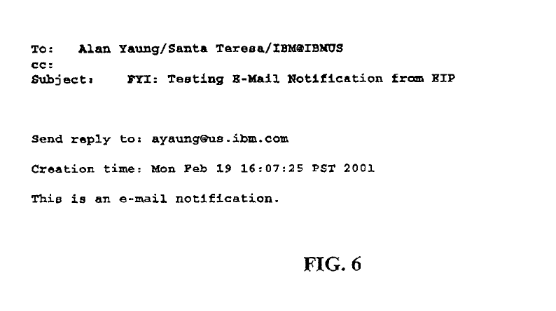

FIG. 6 shows an e-mail notification composed with the parameters specified in application program 400 of FIG. 4. The e-mail address in the “To:” field was resolved from “ayaung@us.ibm.com” to “Alan Yaung/Santa Teresa/IBM@IBMUS” by a local e-mail system. “FYI:” was prefixed to the subject as a result of setting the importance type to 1. The “Send reply to:” field was set to “ayaung@us.ibm.com”, and the “Creation time;” field was set to “Mon Feb 19 16:07:25 PST 2001”.

FIG. 7 is a block diagram of a computer system 700 suitably configured for employment of a preferred embodiment of the present invention. The principal components of system 700 are user workstations 705, 710, a server 715, and an SMTP server 745 coupled for communication with one another via a network 735.

Server 715 includes a processor 720, and is coupled to a memory 725. Memory 725 includes a program module 730 that contains instructions for execution by processor 720 to perform the methods of the present invention as described herein. That is, program module 730 contains instructions for instantiation of DKEMailNotificationSMTP class 110.

SMTP server 745 is an e-mail server. Although SMTP server 745 is shown here as employing SMTP, the present invention is not limited to utilization of SMTP, but instead, may utilize any e-mail protocol.

In system 700, server 715 and SMTP server 745 need not necessarily be located remotely from one another and they need not be implemented as two separate servers. In an actual implementation they may both be located at a single site, and possibly embodied in a single server platform.

While the procedures required to execute the invention are indicated as already loaded into memory 725, they may be configured on a storage media 740 for subsequent loading into memory 725. Storage media 740 can be any conventional storage media such as a magnetic tape, an optical storage media, a compact disk, or a floppy disk. Alternatively, storage media 740 can be a random access memory, or other type of electronic storage, located on a remote storage system.

Assume that a first party at workstation 705 executes an application program (see FIG. 4) that wishes to send an e-mail notification to workstation 710. The application program invokes an API that causes workstation 705 to connect to server 715, and thus, server 715 receives an API call from workstation 705. Server 715 instantiates DKEMailNotificationSMTP class 110 (see FIG. 3). DKEMailNotificationSMTP class 110 commences execution and causes server 715 to connect to SMTP server 745. The application program running on workstation 705 sends an e-mail notification to server 715, which forwards the e-mail notification to SMTP server 745. Thereafter, SMTP server 745 forwards the e-mail notification to a second party, i.e., a recipient, located at workstation 710.

Although the invention is presented herein as involving a first party and a second party, these parties need not literally be people, nor do they need to actually exist. For example, the application running on workstation 705 may be a personal scheduling program that sends to the recipient, via e-mail notification, a reminder of a scheduled event.

E-mail notification is an indispensable feature in enterprise computing. With the e-mail notification capability integrated in a federated content management system, application developers can easily design and implement solutions with e-mail notification. In addition, the enabling e-mail notification complements the federated workflow. Application developers can design sophisticated workflow solutions with e-mail notification for business processes. The enablement of e-mail notification is advantageous for an organization in the business of content management.

It should be understood that various alternatives and modifications of the present invention could be devised by those skilled in the art. The present invention is intended to embrace all such alternatives, modifications and variances that fall within the scope of the appended claims.

What is claimed is:

1. A process, executed in an object-oriented programming environment, for sending an e-mail notification to a recipient, said process comprising:
instantiating an object; and
providing to said object a name of an e-mail server and an e-mail address for said recipient,
wherein said object sends said e-mail notification to said e-mail server for said e-mail address.

2. A process, executed in an object-oriented programming environment, for sending an e-mail notification to a recipient, said process comprising:
instantiating an object; and
providing to said object a name of an e-mail server and an e-mail address for said recipient,
wherein said object connects to said e-mail server and sends said e-mail notification to said e-mail server for said e-mail address.

3. The process of claim 2, wherein said process is employed by a program module in a system having a plurality of back-end servers.

4. The process of claim 2, wherein said process is employed by a program module in a federated content management system.

5. The process of claim 2, wherein said process is invoked by an application program interface (API).

6. A class defined in an object-oriented program module for controlling a processor, comprising:
a method for connecting to an e-mail server; and
a method for sending an e-mail notification to said e-mail server for a recipient.

7. The class of claim 6,
wherein said class, when invoked, instantiates an object that receives a name of said e-mail server and an e-mail address for said recipient, and
wherein said object executes said method for connecting and said method for sending.

8. The class of claim 6, wherein said object oriented program module is in a system having a plurality of back-end servers.

9. The class of claim 6, wherein said object-oriented program module is in a federated content management system.

10. The class of claim 6, wherein said class is invoked by an application program interface (API).

11. A storage media comprising an object-oriented program module that defines a class having:
a method for connecting to an e-mail server; and
a method for sending an e-mail notification to said e-mail server for a recipient.

12. The storage media of claim 11,
wherein said class, when invoked, instantiates an object that receives a name of said e-mail server and an e-mail address for said recipient, and
wherein said object executes said method for connecting and said method for sending.

13. The storage media of claim 11, wherein said object-oriented program module is operable in a system having a plurality of back-end servers.

14. The storage media of claim 11, wherein said object-oriented program module is operable within a federated content management system.

15. The storage media of claim 11, wherein said object-oriented program module is invocable by an application programming interface (API).
